(19) United States
(12) Patent Application Publication
(10) Pub. No.: US 2005/0237241 A1
(43) Pub. Date: Oct. 27, 2005

(54) Antenna for radio frequency identification reader

(76) Inventors: Richard Stewart Garber, St. Paul, MN (US); Collin James LaFave, Portage, WI (US)

Correspondence Address: MERCHANT & GOULD PC, P.O. BOX 2903, MINNEAPOLIS, MN, 55402-0903, US

(21) Appl. No.: 11/117,083

(22) Filed: Apr. 27, 2005

Related U.S. Application Data
(60) Provisional application No. 60/566,137, filed on Apr. 27, 2004.

(51) Int. Cl. H01P 5/12; F25D 23/12

(52) U.S. Cl. 343/700 MS; 333/125

(57) ABSTRACT

An antenna for radio frequency communication, such as for a reader circuit that is configured to be coupled to a coupler of a system for controlling fluid dispensing. The antenna can include a printed circuit board with an aperture and a plurality of windings disposed circumferentially about the aperture. The antenna can also include a U-shaped core having first and second legs coupled by a third leg, the third leg being coupled to the printed circuit board, and the first and second legs extending generally parallel with respect to opposite sides of the printed circuit board over the plurality of windings.

### RELATED APPLICATION

This application claims the benefit of U.S. Patent Provisional Application Ser. No. 60/566,137, filed on Apr. 27, 2004 and entitled “Antenna for Radio Frequency Identification Reader,” the entirety of which is hereby incorporated by reference.

### FIELD OF INVENTION

The present invention relates to radio frequency communication and, more particularly, to an antenna for a radio frequency identification device.

### BACKGROUND OF THE INVENTION

Typically, conventional fluid connectors used for fluid dispensing or fluid transmission have a fluid coupling assembly with a first end connected to a fluid source and a second end connected to a fluid system including a fluid line. The coupling assembly normally includes a male coupler and a corresponding female coupler for receiving the male coupler. The male coupler or the female coupler further includes a mechanical latch for latching and unlatching the male coupler and the female coupler in a coupled and uncoupled state. To place the coupling assembly in the coupled state, the male coupler is inserted into one end of the female coupler, with a seal member extending therebetween to create a fluid tight seal. Accordingly, the male coupler and the female coupler define a passageway for fluid flow therethrough when the coupling assembly is in the coupled state.

In addition, fluid connectors having radio frequency identification readers and tags for distinguishing one mating coupler from another are known. See, for example, U.S. Pat. No. 6,649,829 to Garber et al. In example embodiments disclosed therein, couplers include radio frequency identification readers and tags that communicate when brought in close proximity to one another. To facilitate this communication, each reader and tag includes an antenna. Each antenna disclosed in U.S. Pat. No. 6,649,829 includes an annular ring that is coupled by a soldered connection to a printed circuit board (PCB) of the respective reader or tag.

It is desirable to configure such antennas used in radio frequency communication to be as small and robust as possible.

### SUMMARY OF THE INVENTION

The present invention relates to radio frequency communication and, more particularly, to an antenna for a radio frequency identification device.

One aspect of the present invention relates to an antenna for radio frequency communication having a reader circuit including a printed circuit board defining an aperture and a plurality of windings disposed circumferentially about the aperture, and a core including a first leg coupled to the printed circuit board and extending over the plurality of windings.

Another aspect of the invention relates to a system for controlling fluid dispensing including a fluid source, and a first coupler connected to the fluid source, the first coupler having a body including first and second ends defining an opening longitudinally therethrough, and a radio frequency identification tag mounted on the body, the radio frequency identification tag enabling radio frequency communication to and from the radio frequency identification tag. The example system also includes a second coupler having a body including first and second ends, the ends defining an opening longitudinally therethrough, and a reader circuit mounted on the body and including a printed circuit board defining an aperture and a plurality of windings disposed circumferentially about the aperture, and a U-shaped core including first and second legs coupled by a third leg, the third leg being coupled to the printed circuit board, and the first and second legs extending generally parallel with respect to opposite sides of the printed circuit board over the plurality of windings, the reader circuit enabling radio frequency communication to and from the second coupler. The radio frequency communication between the first coupler and the second coupler is enabled when the body of the first coupler at least partially engages the body of the second coupler.

A variety of additional details will be set forth in part in the description which follows. Both the foregoing general description and the following detailed description are exemplary and explanatory only and are not restrictive of particular aspects of the invention disclosed.

### BRIEF DESCRIPTION OF THE DRAWINGS

FIG. 1 represents a schematic diagram of one embodiment of a system for controlling fluid dispensing and transmission in accordance with the principles of the present invention.

FIG. 2 represents a block diagram of one embodiment of a read and write transmitter device for a second coupler in accordance with the principles of the present invention.

FIG. 3 represents an exploded view of one embodiment of a first coupler having an example transmitter attached thereto in accordance with the principles of the present invention.

FIG. 4 represents an exploded view of one embodiment of a second coupler having a read and write transmitter incorporated therewith in accordance with the principles of the present invention.

FIG. 5A represents a side view of the first coupler of FIG. 3 and the second coupler of FIG. 4 in one embodiment of a non-connected state in accordance with the principles of the present invention.

FIG. 5B represents a side view of the first coupler of FIG. 3 and the second coupler of FIG. 4 in one embodiment of a pre-coupled state.

FIG. 5C represents a side view of the first coupler of FIG. 3 and the second coupler of FIG. 4 in one embodiment of a connected coupled state.

FIG. 6 represents a perspective view of one embodiment of a radio frequency antenna in accordance with the principles of the present invention.

FIG. 7 represents a side view of the example antenna of FIG. 6.

FIG. 8 represents an end view of the example antenna of FIG. 6.

FIG. 9 represents a cross-sectional view of the example antenna of FIG. 8 taken along line 9-9.

FIG. 10 represents a side view of one embodiment of an antenna core in accordance with the principles of the present invention.

FIG. 11 represents an end view of the example antenna core of FIG. 10.

FIG. 12 represents a side view of another embodiment of a radio frequency antenna core in accordance with the principles of the present invention.

FIG. 13 represents a side view of another embodiment of a radio frequency antenna core in accordance with the principles of the present invention.

FIG. 14 represents a side view of another embodiment of an antenna core in accordance with the principles of the present invention.

FIG. 15 represents a side view of another embodiment of an antenna core in accordance with the principles of the present invention.

FIG. 16 represents a side view of another embodiment of an antenna core in accordance with the principles of the present invention.

FIG. 17 represents a side view of another embodiment of an antenna core in accordance with the principles of the present invention.

FIG. 18 represents a side view of another embodiment of an antenna core in accordance with the principles of the present invention.

FIG. 19 represents a side view of another embodiment of an antenna core in accordance with the principles of the present invention.

### DETAILED DESCRIPTION OF THE PREFERRED EMBODIMENT

In the following description of example embodiments, reference is made to the accompanying drawings which form a part hereof, and in which is shown illustrative embodiments. Other embodiments may also be utilized, as changes may be made without departing from the scope of the present invention.

The present invention relates to radio frequency communication and, more particularly, to an antenna for a radio frequency identification device. Although the term “antenna” is used herein to describe certain structures, it should not be construed as limiting. For example, embodiments of antennas disclosed herein can also be described in some applications as transformers or inductors.

Illustrative embodiments of the present invention relate to a connector apparatus with an incorporated control component (i.e., transmitter components used therein) for controlling connection between coupling halves of the connector apparatus and for controlling fluid dispensing and transmission through the connector apparatus. In the illustrated embodiments, the transmitters communicate wirelessly. The connector apparatus can be incorporated with a fluid source and fluid line for fluid dispensing in a fluid dispensing system or incorporated along a fluid transfer line.

Examples of such systems are described in U.S. Pat. No. 6,649,829 to Garber et al., filed May 21, 2002 and entitled “Connector Apparatus and Method for Connecting the Same for Controlling Fluid Dispensing,” the entirety of which is hereby incorporated by reference.

Although embodiments of the present invention are described with respect to connector systems, principles disclosed herein are equally applicable to other applications as well, as noted below.

I. Example Fluid Dispensing System

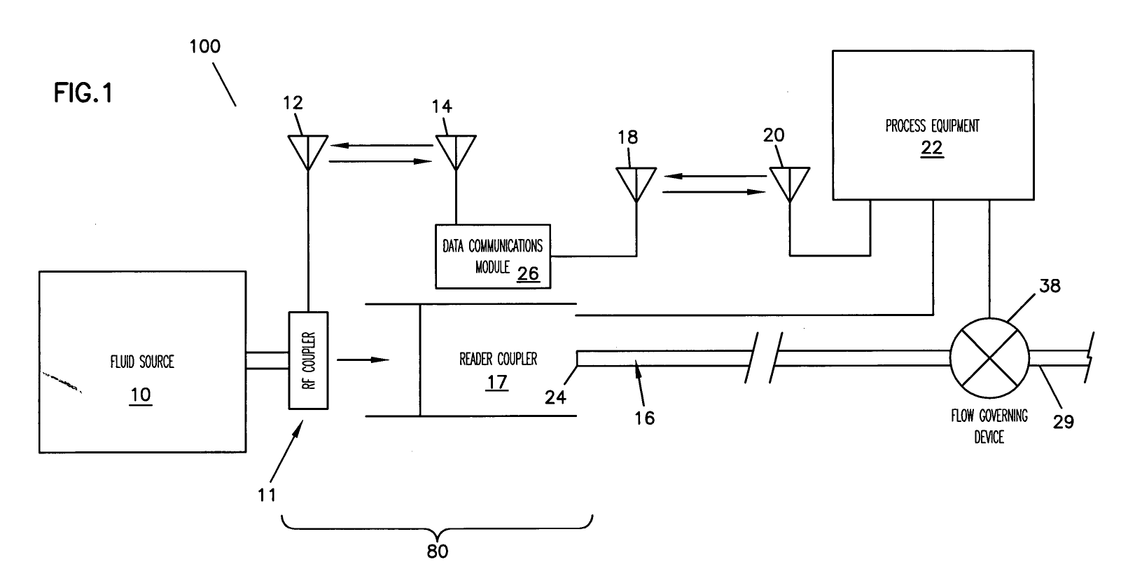

Referring now to the drawings, FIG. 1 shows a connector apparatus 80 incorporated in a fluid dispensing system 100. A radio frequency (“RF”) coupler 11 including a first transmitter is attached to a fluid source 10. The fluid source 10 can be any suitable container for holding fluid and allowing attachment with a coupler, such as coupler 11. A cooperating coupler or reader coupler 17 is releasably connectable with the RF coupler 11, and is associated with a fluid transfer line 16, such as a hose.

The reader coupler 17 connects proximate a first end 24 of the fluid transfer line 16. The RF coupler 11 can be a disposable or reusable coupler having a radio frequency identification device (“RFID”) attached to the RF coupler 11, i.e., a transponder or a tag, to identify the RF coupler 11 and to transmit and receive information. The RF coupler 11 transmits and receives information to and from a second transmitter disposed on the reader coupler 17.

The second transmitter includes a data communication module 26 mounted on the reader coupler 17. The data communication module 26 of the reader coupler 17 can include a short range, low power circuit. The RF coupler 11 and reader coupler 17 communicate through antennas 12 and 14, described further below. In the illustrated embodiments, communication between the transmitters on the RF coupler 11 and the reader coupler 17 is enabled when the couplers are in close proximity.

For example, in one embodiment the RF and reader couplers 111 and 17 are positioned in a pre-coupled position, where the couplers are at least partially connected or engaged. For example, the faces of the RF coupler 11 and reader coupler 17 are oriented and positioned coaxially in an end to end alignment, such that further engagement of the coupling halves initiates interlocking. In the pre-coupled position, the RF coupler 11 and reader coupler 17 resemble a one to one relationship at a single time such that the reader coupler is prevented from connecting and communicating with another coupler unless the RF coupler 11 is removed from the pre-coupled position a distance away from the reader coupler 17.

In this configuration, the read range of the reader coupler is defined such that the reader coupler communicates with the RF coupler when an intended interconnection of the couplers is pending, thereby ignoring other local couplers with RFID tags that are not being connected with the reader coupler. Communication between coupling halves is constructed and arranged where a reader coupler, such as 17, communicates with a respective RF coupler, such as 11, one at a time.

In some embodiments, the circuitry of the reader coupler is tuned to have a maximum communication range equivalent to a pre-coupled axial separation distance of the reader coupler and RF coupler. The circuitry of the reader coupler can be tuned to an appropriate read range or communication distance by varying factors such as, but not limited to, antenna size, antenna configuration and the power of the RF emission. Furthermore, the communication distance may vary according to physical constraints of the coupler, such as coupler size. For instance, larger couplings requiring greater engagement also may require longer communication distances, such as, fluid couplings equipped with double acting flow shut off valves.

In illustrated embodiments, the short range, low power circuit is intended for reading and writing at a distance of less than 5 cm between the reader coupler 17 and the RF coupler 11. In one embodiment, the short range circuit is intended to operate at a distance of 4-5 cm. The short range low power circuit includes a single operating frequency. In the illustrated embodiment, the short range circuit of the data communication module 26 includes a single operating frequency of at least 13 MHz.

When the couplers are properly positioned and within the desired communication range, the data communication module 26 transmits and receives information to and from the process equipment 22, so as to establish information exchange between the RF coupler 11 and the process equipment 22. As shown in FIG. 1, in one embodiment a flow governing device 38 is connected proximate a second end 29 of the fluid transfer line 16, and is operatively connected with and in communication with the process equipment 22. The flow governing device 38 can also be disposed at different positions along the fluid transfer line 16 and may be incorporated at the reader coupler 17.

The RF coupler 11 is powered up by transmitting a signal from the reader circuit mounted on the reader coupler 17 to the RF coupler 11. The RF coupler 11 transmits a reply signal, which includes identification information contained in an RFID tag of the RF coupler 11, from the RF coupler 11 to the reader coupler 17. The reply signal is transmitted to the process equipment 22 through the reader coupler 17. The process equipment 22 interprets the reply signal received, and identifies the RF coupler 11 interrogated by the reader coupler 17 to indicate whether the RF coupler and the reader coupler 17 are matched for a positive connection. Further, based on the identity of the RF coupler, the process equipment manipulates the flow governing device 38 disposed on and within the fluid transfer line 16 to enable or disable fluid flow and/or control fluid flow parameters through the RF coupler 11, reader coupler 17, and fluid transfer line 16.

The process equipment 22 manipulates the flow governing device 38, thereby enabling or disabling fluid flow through the RF coupler 11, reader coupler 17, and fluid transfer line 16 from the fluid source 10. The flow governing device 38 can be any suitable device that may be enabled or disabled, for example an electromechanical device including but not limited to a solenoid, valve, or pump. Further, the flow governing device can be incorporated and/or integral with the reader coupler 17, such that the reader coupler acts as the flow governing device 38, and is manipulated either directly from the data communication module 26 or indirectly from the data communication module 26 through the process equipment 22.

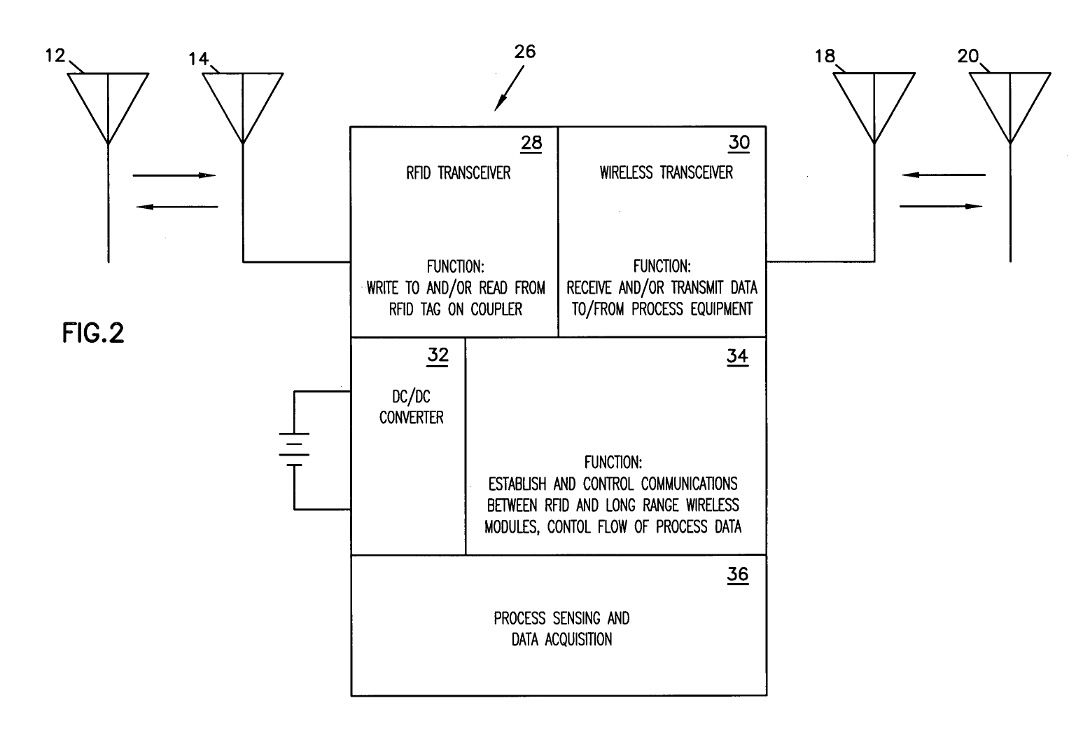

The data communication module 26, as shown in FIG. 2, includes: a RFID transceiver 28 for writing to and/or reading from the RFID tag or transmitter attached to the RF coupler 11, a transceiver 30 (such as a wireless transceiver, or other RF protocol transceiver or physical connection) for receiving and/or transmitting data from and to process equipment 22, a DC/DC converter 32 for power supply, a microcontroller 34, and a process sensing and data acquisition module 36. In one embodiment, the transceiver 30 is a Bluetooth wireless transceiver. As above, the data communication module 26 mounts onto the reader coupler 17, such that when the RF coupler 11 and the reader coupler 17 are at least partially connected in a pre-coupled position, the RF capabilities of both the RF coupler 11 and the data communication module 26 of the reader coupler 17 are in close proximity, enabling communication between the RF coupler and reader coupler through antennas 12 and 14.

As above, when the RF coupler 11 is pre-coupled with the reader coupler 17, antenna 14 transmits signals to antenna 12, the signals are used to power up the RF coupler 11 including, for instance, an RFID tag on the RF coupler 11, thereby enabling processing of the signals by the RFID tag, and the RFID tag modulates the RF field, using antenna 12, to transmit a reply signal that is received by antenna 14 of the reader coupler 17. The RFID tag is attached onto the RF coupler 11, and the data communication module 26 is mounted on the reader coupler 17. The circuitry of the reader coupler 17 can be tuned to an appropriate read range or communication distance by varying factors such as but not limited to antenna size, antenna configuration and the power of the RF emission. Furthermore, the communication distance can vary according to physical constraints of the coupler, such as coupler size. In example embodiments, the tag size is constructed and arranged so as to be compact and suitable for couplers having ⅛ to 3 inch diameter in size.

In one example, the RF signals are transmitted at a single radio frequency of 13.56 MHz. The RFID tag information may include specific information for properly connecting couplers in a dispensing system, i.e., codes to identify the coupler, its mode of operation, and security markings to prevent unauthorized use. For example, the RFID tag information may include some or all of the following data.

1) Manufacturing Date—the coupler has a limited usage time from manufacture, and thus the process equipment and associated flow governing device would not be enabled to allow fluid flow if the RF coupler is out of date.

2) Expiration Date—The process equipment and associated flow governing device would not be enabled to allow fluid flow if the RF coupler passed the expiration date.

3) Single Use and Reuse Information—Whether the coupler is designed to be disposable or reusable.

4) Single Use Information—If the RF coupler has been used, the tag would be rewritten to indicate such information. Any subsequent attempts to reuse the coupler would be recognized by the process equipment and the flow governing device would not be enabled.

5) Limited Multiple Reuse—The process equipment would automatically count the number of use cycles, and may rewrite the tag with this information. Thus, when the designed number of use cycles has been reached, the flow governing device would not be enabled.

Upon receiving the RFID tag information, the transceiver 28 communicates with transceiver 30 controlled by microcontroller 34. The microcontroller 34 not only establishes and controls communications between the RFID transceiver 28 and the wireless transceiver 30, but also controls the flow of process data. Then, the information received from the RFID tag on the RF coupler 11 is transmitted from antenna 18 of the transceiver 30 to the process equipment 22 via antenna 20. Communication between the process equipment 22 and the data communication module 26 can occur over long ranges. The transceiver 30 can be a wireless transceiver or other RF protocol transceiver or a wired connection. Information can be transmitted between the transceiver 30 and the process equipment 22 at a radio frequency (for example, 2.4 GHz). Although FIG. 2 shows a wireless link between the data communication module 26 and the process equipment 22, a physical hardwired link also can be established therebetween.

When the process equipment 22 receives the information from the data communication module 26, it processes the information to identify the RF coupler 11, and manipulates the flow governing device 38 according to the information transmitted by the RFID tag of the RF coupler. If the RF coupler 11 has a proper identification, then the process equipment 22 manipulates the flow governing device 38 to enable fluid transfer. Otherwise, the process equipment 22 maintains the flow governing device 38 in a disabled position.

In addition, the process equipment 22 can control fluid flow under particular parameters, such as but not limited to pressure, temperature or flow rate, etc., as indicated in the information of the RFID tag of the RF coupler 11. The process equipment 22 also can modify some information of the RFID tag to update the information stored in the RFID tag. For example, the process equipment 22 modifies single use information to prevent further re-use of the RF coupler 11 upon reconnection with the fluid dispensing system 100. Such modified information is first transmitted to the transceiver 30, and then upon communicating with the RFID transceiver 28 via microcontroller 34, it is written into the RFID tag attached to the RF coupler 11.

The process sensing and data acquisition module 36 mounted in the data communication module 26 is used to measure the fluid flow parameters such as pressure, temperature, pH value, flow rate, and provides the corresponding electrical signals, so that the process equipment 22 can receive confirmation of the fluid flow parameters, as indicated on the RFID tag of the RF coupler.

II. RF Coupler

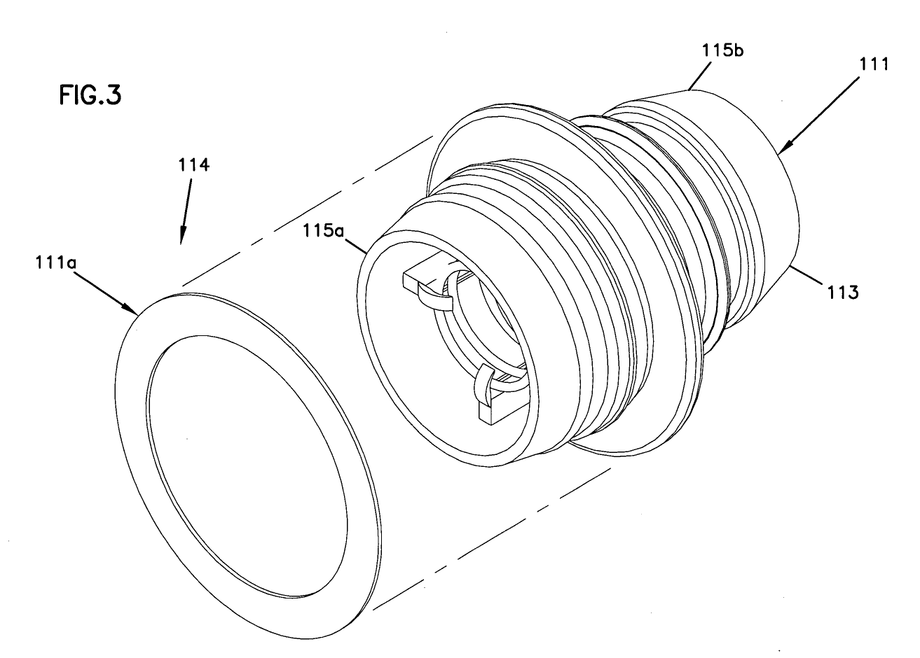

FIG. 3 illustrates one embodiment for a first RF coupler 111. The first coupler 111 is configured to be connected with a fluid source, such as fluid source 10, at a first end 115a, and can be suitably adapted to connect with a fluid line, such as fluid transfer line 16, through coupling with a second coupler at a second end 115b. As illustrated, the second end 115b includes a tapered surface adaptable for connection with a second coupler, such as a conventional quick connect and disconnect coupler.

The first coupler 111 includes a first transmitter 114 having an antenna 111a. As shown in FIG. 3, the first antenna 11a is disposed about an outer surface of the first coupler 111. In one embodiment, the first antenna 11a is attached to a transponder or tag storing identification and operation information respective to the first coupler 111, and includes an antenna embedded therein. As illustrated, the first antenna 111a represents an annular ring. The first antenna 11a can be disposed at other positions on the first coupler 111, and can be constructed and arranged of different shapes and sizes.

The first antenna 111a can be arranged and constructed as a thin film molded onto the coupler 111 to transmit signals. A battery source (not shown) can be mounted on the coupler 111 to provide a power source for operation.

III. RF Reader Coupler

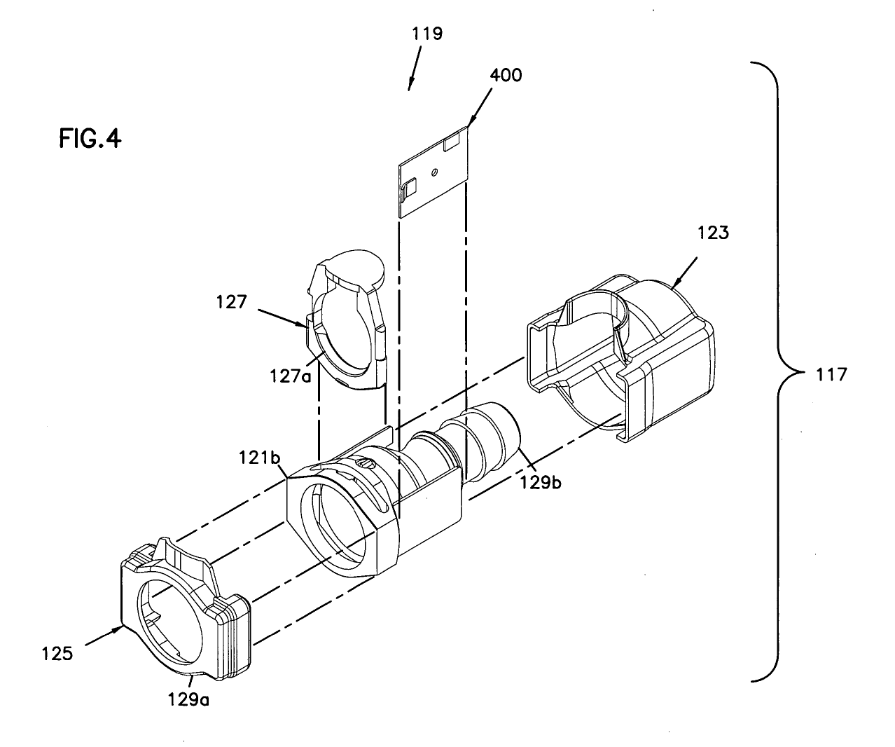

FIG. 4 illustrates a second RF coupler 117. The second coupler 117 includes a second transmitter 119. The second coupler 117 is suitably adapted at a first end 129a for connection with a mating coupler, such as first coupler 111 or RF coupler 11. Further, second coupler 117 is suitably adapted at a second end 129b for connection with a fluid line, such as the fluid transfer line 16.

A latch 127 is disposed adjacent a cap 125. The latch 127 is used to secure the second coupler 117 to a mating first coupler, such as coupler 11 or 111. In one embodiment, the latch 127 is moveable within the body 121 in a direction transverse to the longitudinal flow path of the coupler 117.

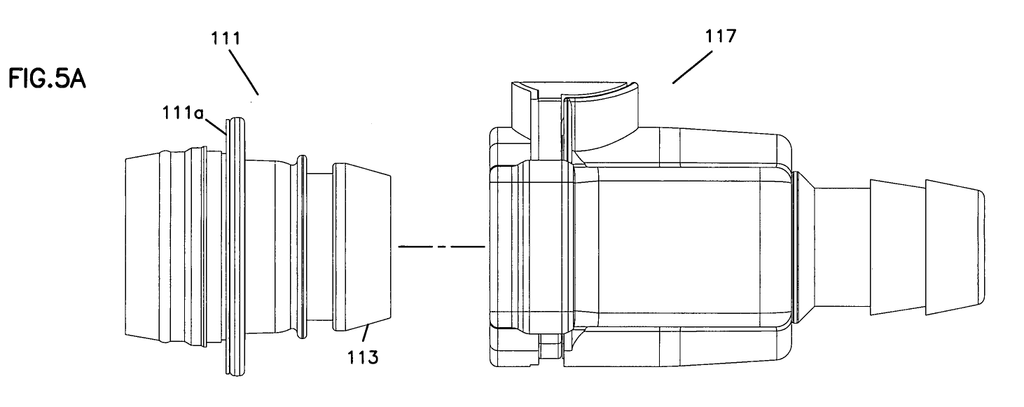

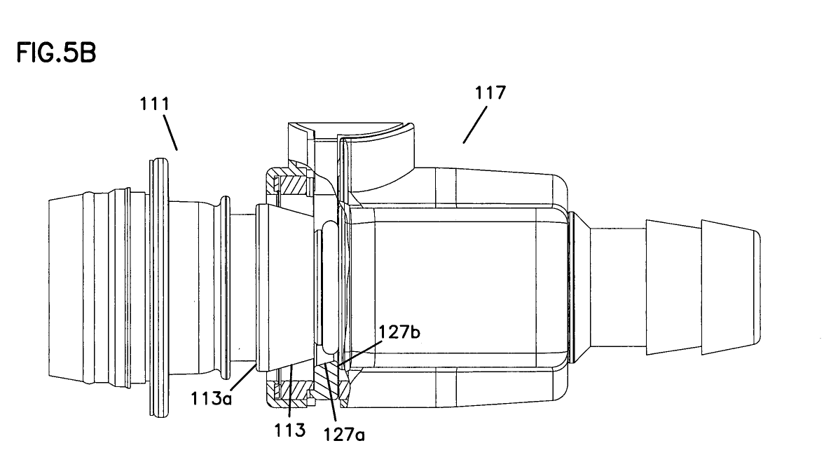

In one example, the latch 127 includes a tapered surface 127a that corresponds and engages with a surface on a mating coupler, such as tapered surface 113 (see FIG. 3). Further, the latch 127 is spring biased such that, by pressing the latch 127 downward, the tapered surface 127a moves such that a mating coupler can be inserted. The tapered surfaces 127a, 113 are slideable relative to one another so as to allow the couplers to connect. After the tapered surfaces 127a, 113 have slid past each other, release of the latch 127 enables transverse surfaces 113a, 127b that are orthogonal to the respective tapered surfaces 113, 127a to abut and secure the coupling halves together. See FIGS. 5A-5C described below.

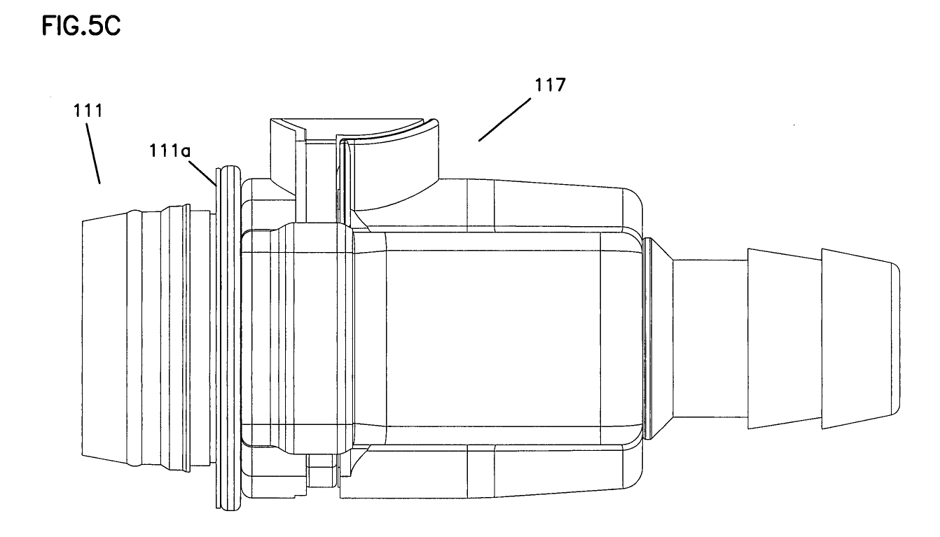

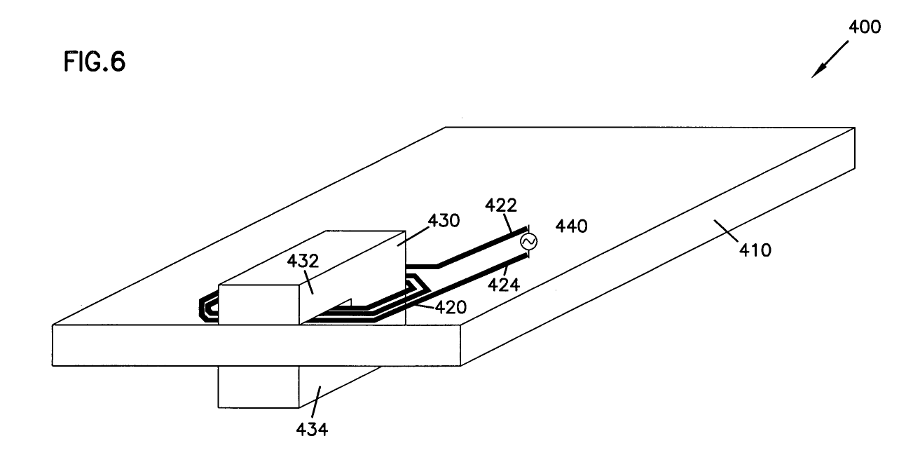

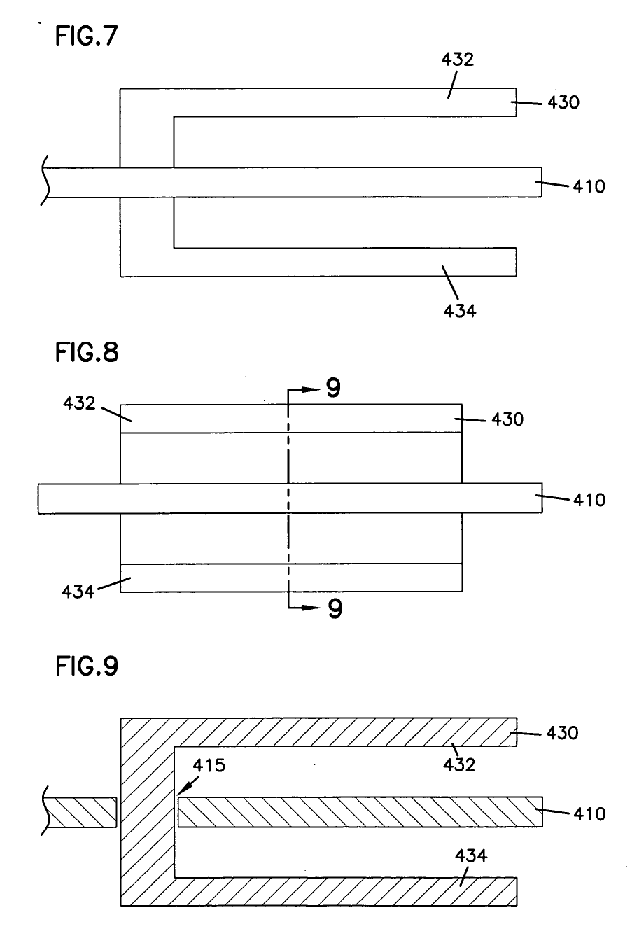

In example embodiments, the second RF coupler 117 includes a second transmitter 119 that is an RF device having an RF antenna 400 arranged and constructed such that it is mounted on second coupler 117. The second transmitter 119 can utilize antenna 400 to transmit signals. FIGS. 6-11, described further below, illustrate the example antenna 400 in detail. Other sizes, shapes, and configurations for second transmitter 119 also may be employed.

FIGS. 5A-5C illustrate the first coupler 111 and the second reader coupler 117 being connected. FIG. 5A shows the first coupler 111 and second coupler 117 in a ready position for connection having the first transmitter 11a and second transmitter 119 (not shown) each mounted thereon. FIG. 5B shows the first coupler 111 and the second reader coupler 117 in a pre-coupled state. FIG. 5C illustrates the connected state of couplers 111 and 117, after positive connection has been confirmed during signal communication in the pre-coupled state.

In operation, the second coupler 117 interrogates the first coupler 111 when in the pre-coupled state (FIG. 5B) to determine whether a positive identification and proper connection is made. After positive identification has been confirmed, the couplers 111, 117 can be further engaged in the connected state (FIG. 5C) to continue further communication in manipulating a fluid control device, such as flow governing device to control fluid flow and fluid flow parameters thereof.

IV. RF Antenna for Reader Coupler

FIGS. 6-11 illustrate one embodiment of antenna 400 for second coupler 117. Antenna 400 includes a printed circuit board (PCB) 410 having etched windings 420 thereon, and a U-shaped core 430 coupled to PCB 410.

As illustrated, core 430 is positioned to extend through an aperture 415 in PCB 410. See FIG. 9. Windings 420 are circumferentially spaced about the aperture 415, and legs 432 and 434 of the core 430 are positioned to extend over the windings 420. See FIG. 6.

Ends 422 and 424 of the windings 420 are coupled to an RF signal 440. For example, ends 422 and 424 can be coupled to data communication module 26, described above.

In one embodiment, the core 430 is attached to the PCB 410 by a locking clip (not shown) made of plastic or other suitable material. Other methods can also be used to couple core 430 to PCB 410 such as, for example, a potting compound.

In one embodiment, the core 430 is made of Material 4F1 manufactured by Ferroxcube USA of El Paso, Tex. Other materials can also be used such as, for example, Ferroxcube 4B1 or 3C85, Hitachi ND12S, and Ferronics P.

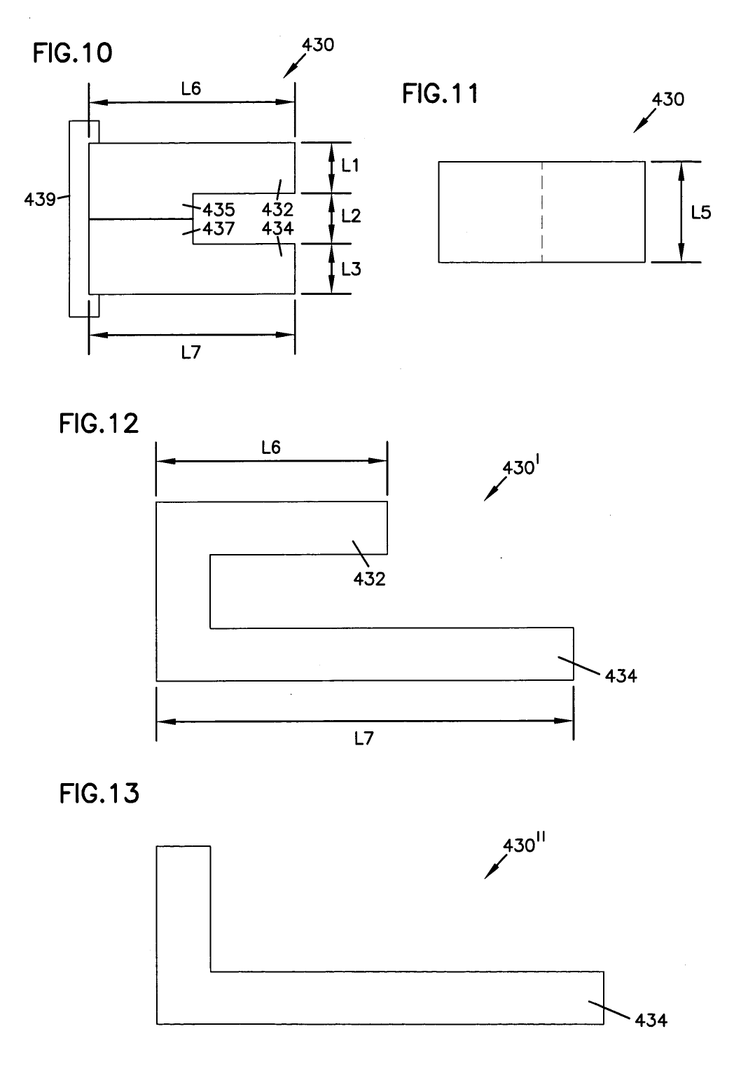

FIGS. 10 and 11 illustrate the core 430 in greater detail. In the illustrated embodiment, the core 430 is formed of two L-shaped sections 435 and 437 held together by a clip such as, for example, spring clip 439. See FIG. 10.

In the illustrated embodiment, a width L1 and L3 of each leg 432 and 434 is approximately 25-75 thousandths of an inch, more preferably each being 50 thousandths of an inch. A width L2 of the gap creating the U-shape is also approximately 25-75 thousandths of an inch, more preferably 50 thousandths of an inch. Dimension L5 for a width of the core 430 is approximately 75-125 thousandths of an inch, more preferably 100 thousandths of an inch. Lengths L6 and L7 for each leg 432 and 434 of the core 430 are approximately 150-300 thousandths of an inch, more preferably 200 thousandths of an inch. Other dimensions for the core 430 can also be used, and dimensions can vary between legs 432 and 434.

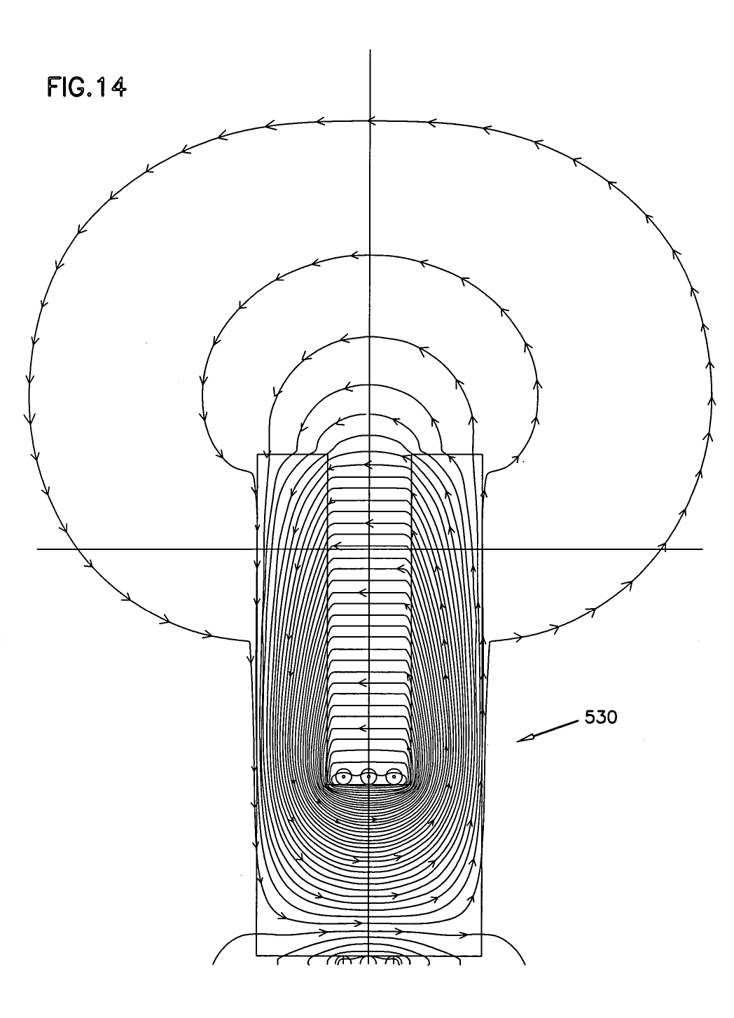

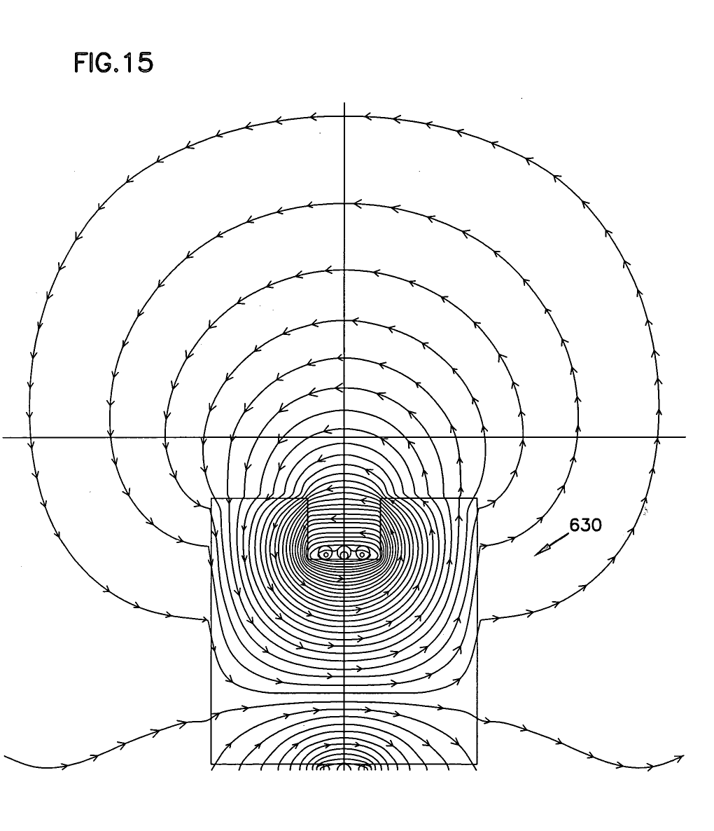

For example, the length L5 of one or both of the legs 432 and 434 of the core 430 can be varied to vary the resulting magnetic field created by the antenna. For example, the length L6 of leg 432 of the core 430′ shown in FIG. 12 is shortened with respect to leg 434, so that core 430′ is generally J-shaped. In another example illustrated in FIG. 13, leg 432 is completely removed from core 430″ so that core 430″ is generally L-shaped.

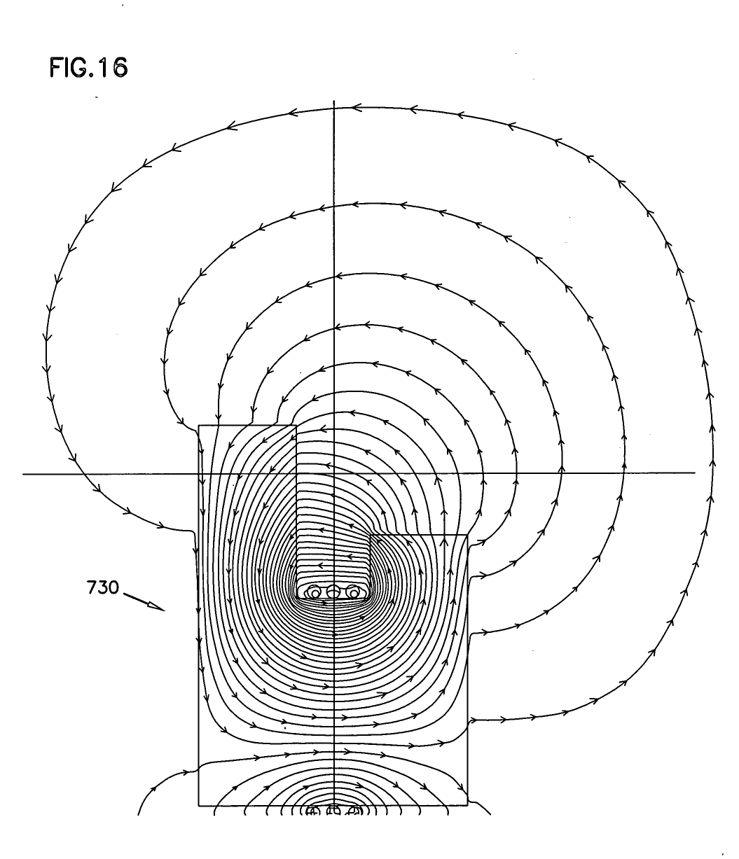

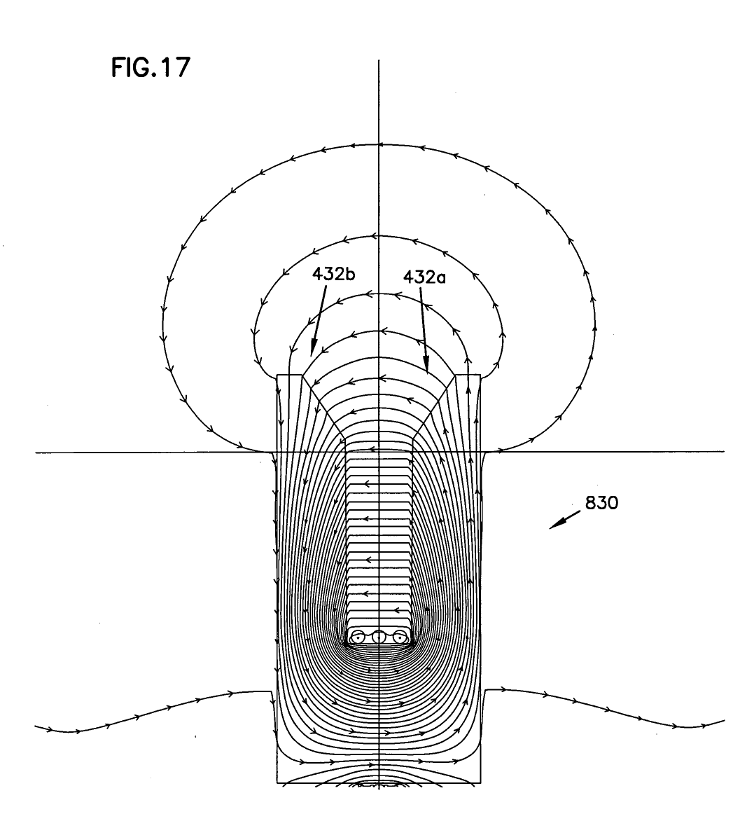

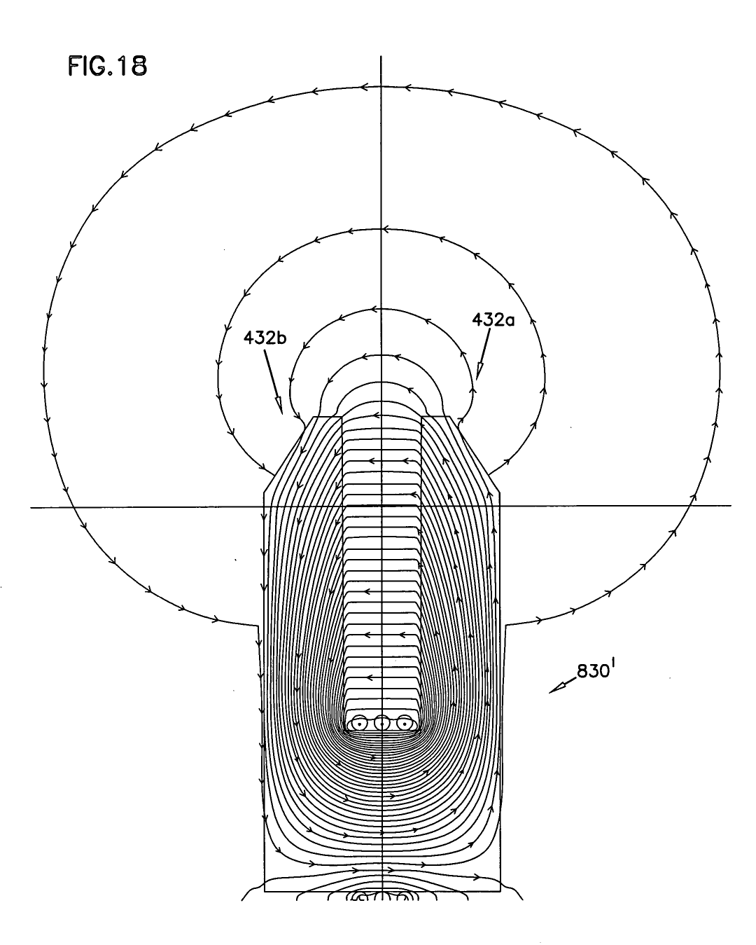

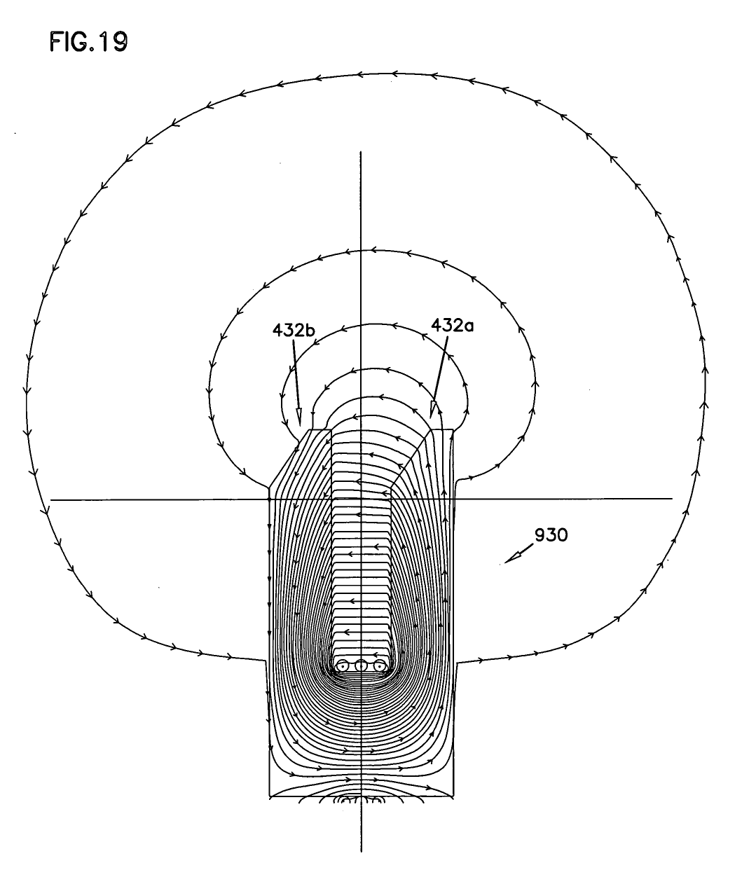

Further, the shape of the core 430 can be modified in other ways as desired to modify the magnetic field generated by the antenna. In this manner, the magnetic field created by the core can be increased or decreased in size and/or shape, as desired. For example, as illustrated in FIGS. 14-16, modification of the shape and size of the legs of example cores 530, 630, and 730 can result in magnetic fields (i.e., magnetic flux distribution) of differing shapes and sizes. In other embodiments, such as example cores 830, 830′, and 930 illustrated in FIGS. 17-19, the shape of free ends 432a, 434a of the legs of the core can be varied to affect the magnetic field distribution. For example, one or more of the free ends 432a, 434a of the legs of cores 830, 830′, and 930 illustrated in FIGS. 17-19 are tapered to form, for example, a generally triangular or trapezoidal shape.

Configuring RF antennas as described herein can result in various advantages. For example, the design of the antenna, which allows the core to be coupled directly to the PCB, can be robust, in that no soldered connections are necessary to couple the core to the PCB. Also, impedance discontinuities due to soldered connections can be minimized as well. In addition, such configurations allow the RF antennas to be smaller than conventional RF antennas.

Further, because the shape of the core can be easily varied, the magnetic field of the antenna can be easily optimized for a given application. For example, the antenna can be easily modified to extend the read range of the interrogator or to increase efficiency. In other embodiments, the shape of the core can be configured to focus the resulting magnetic field in a narrow area to thereby optimize energization of only one tag at a time to reduce misidentification or interference due to neighboring tags.

Although the present invention has been discussed toward the application of fluid coupling technology, the structures and configurations of the connector apparatuses of the present invention can also be applied to other couplings such as, but not limited to, electrical couplings and other quick connect and disconnect couplings.

Having described the embodiments of the present invention, modifications and equivalents may occur to one skilled in the art. It is intended that such modifications and equivalents shall be included with the scope of the invention.

1. An antenna for radio frequency communication, comprising:
a printed circuit board defining an aperture, and including a plurality of windings disposed circumferentially about the aperture; and
a core coupled to the printed circuit board, the core extending through the aperture and over the plurality of windings.

2. The antenna of claim 1, wherein the core is U-shaped.

3. The antenna of claim 1, wherein the core includes first and second legs.

4. The antenna of claim 3, wherein the first and second legs form a U-shaped core.

5. The antenna of claim 3, wherein the first leg of the core is longer than the second leg.

6. The antenna of claim 3, wherein the first and second legs extend generally parallel with respect to opposite sides of the printed circuit board.

7. The antenna of claim 3, wherein a free end of the first leg is tapered.

8. The antenna of claim 7, wherein a free end of the second leg is tapered.

9. The antenna of claim 1, wherein the antenna is configured to be coupled to a coupler of a system for controlling fluid dispensing.

10. A system for controlling fluid dispensing, comprising:
a fluid source;
a first coupler connected to the fluid source, the first coupler having a body including first and second ends defining an opening longitudinally therethrough, and a radio frequency identification tag mounted on the body, the radio frequency identification tag enabling radio frequency communication to and from the radio frequency identification tag; and
a second coupler having a body including first and second ends, the ends defining an opening longitudinally therethrough, and a reader circuit mounted on the body and including a printed circuit board defining an aperture and a plurality of windings disposed circumferentially about the aperture, and a U-shaped core including first and second legs coupled to the printed circuit board, and the first and second legs extending generally parallel with respect to opposite sides of the printed circuit board over the plurality of windings, the reader circuit enabling radio frequency communication to and from the second coupler;
wherein radio frequency communication between the first coupler and the second coupler is enabled when the body of the first coupler at least partially engages the body of the second coupler.

11. The system of claim 10, wherein the first and second legs are coupled to form the U-shaped core.

12. The system of claim 10, wherein the first leg of the core is longer than the second leg.

13. The system of claim 10, wherein a free end of the first leg is tapered.

14. The system of claim 13, wherein the free end of the first leg forms a triangle or trapezoid.

15. The system of claim 13, wherein a free end of the second leg is tapered.

16. A system, comprising:
a first coupler having a body including first and second ends, and a radio frequency identification tag mounted on the body, the radio frequency identification tag enabling radio frequency communication to and from the radio frequency identification tag; and
a second coupler having a body including first and second ends, and a reader circuit mounted on the body and including a printed circuit board defining an aperture and a plurality of windings disposed circumferentially about the aperture, and a U-shaped core including first and second legs and being coupled to the printed circuit board, the first and second legs extending generally parallel with respect to opposite sides of the printed circuit board over the plurality of windings, the reader circuit enabling radio frequency communication to and from the second coupler;

17. The system of claim 16, wherein radio frequency communication between the first coupler and the second coupler is enabled when the body of the first coupler at least partially engages the body of the second coupler.

18. The system of claim 16, wherein the first and second legs are coupled to form the U-shaped core.

19. The system of claim 16, wherein the first and second couplers are fluid couplers.

20. The system of claim 16, wherein the first and second couplers are electrical couplers.
